(19) United States
(12) Patent Application Publication
(10) Pub. No.: US 2008/0269523 A1
(43) Pub. Date: Oct. 30, 2008

(54) Preparation of Aminoaryl and Aminoheteroaryl Boronic Acids and Derivatives Thereof

(76) Inventors: Christoph J. Kressierer, Regensburg (DE); Bernd Lehnemann, Koln (DE); Jorg Jung, Floersheim (DE)

Correspondence Address: PROPAT, L.L.C., 425-C SOUTH SHARON AMITY ROAD, CHARLOTTE, NC, 28211-2841, US

(21) Appl. No.: 12/108,621

(22) Filed: Apr. 24, 2008

(30) Foreign Application Priority Data
Apr. 27, 2007 (DE) 10 2007 020 401.0
May 31, 2007 (DE) 10 2007 025 449.2

(51) Int. Cl. C07F 5/04

(52) U.S. Cl. 564/8

(57) ABSTRACT

The invention relates to a method for preparation of aminoaryl- or aminoheteroarylboronic acids and esters and salts thereof in which an optionally substituted aminoaryl or aminoheteroaryl compound is protected at its nitrogen site via condensation with a carbonyl compound, subsequently metalated and converted with a suitable boron compound. Depending on the subsequent work-up and removal of the protective group, the corresponding boronic acid, the anhydride or the boronic acid ester thereof is obtained

### CROSS-REFERENCE TO RELATED APPLICATIONS

This application claims priority to German Patent Application No. 10 2007 020 401.0, filed Apr. 27, 2007 and German Patent Application No. 10 2007 025 449.2, filed May 31, 2007; both of which are hereby incorporated by reference herein in their entirety.

### FIELD OF THE INVENTION

The invention relates to a method for preparation of aminoaryl- and aminoheteroarylboronic acids and esters and salts thereof. The present invention more particularly relates to methods in which an optionally substituted aminoaryl or aminoheteroaryl compound is protected at its nitrogen site via condensation with a carbonyl compound, subsequently metalated and then converted with a suitable boron compound, whereby after reconditioning and removal of the protective group the corresponding boronic acid, the anhydride or the boronic acid ester thereof is obtained.

### BACKGROUND OF THE INVENTION

Use of transition-metal catalyzed reactions, particularly for linkage of carbon-carbon-bonds with palladium- or nickel catalysts, has in recent years increasingly been introduced in industrial synthesis of pharmaceutical agents, speciality and fine chemicals, because under very mild conditions they often proceed with good chemo-selectivities. Therein, generally an alkenyl-, alkinyl-, aryl- or heteroaryl halide is coupled with an alkene (Heck reaction) or a metal-organic compound. In particular, asymmetrically substituted biphenyl derivatives, which are not accessible through classical synthetic methods, can be produced by this method. Therein, the most frequently applied method is the Suzuki- or Suzuki-Miyaura-coupling, in which boronic acids or their derivatives, occasionally also alkylboranes are used as metal-organic coupling partners Due to their relatively low reactivity these boron compounds tolerate the presence of many functional groups in the molecule and can even be converted in aqueous reaction media. Also, their toxicity is low compared to other similar reactive organometallic compounds, such as organo-tin compounds (Stille-coupling).

Organic arylboronic acids and their derivatives are typically produced by conversion of an aryllithium- or arylmagnesium compound with a boronic acid trialkyl ester and subsequent aqueous acidic hydrolysis.

This synthetic pathway cannot be directly applied to aminoaryl- or aminoheteroarylboronic acids, since the two relatively acidic hydrogen atoms of the amino group render the production of an organometallic compound of the aminoarene or aminoheteroarene impossible. Simple protection of the amino group, as common in peptide synthetic, is insufficient, because the second present hydrogen atom is reactive towards polar organometallic compounds.

The literature related to this subject describes attempts to introduce the amino group in phenylboronic acid by nitrating the phenylboronic acid and reducing the introduced nitro-group. Therein, an isomer mixture is produced, which depending on reaction conditions consists mainly of ortho- or meta-nitrophenylboronic acid (each 60 to 70% yield); the para-nitrophenylboronic acid could only be obtained as byproduct in very low amounts, however, it could not be fully characterized. The ortho- and meta-aminophenylboronic acids were prepared with medium yields by reduction of nitro compounds, either with iron(II)-salts or hydrogen on platinum, and were isolated as carbonic acid anilides. (Seaman and Johnson, J. Am. Chem. Soc. 1931, 53, 713). During nitration, always a certain amount of nitrobenzole and boronic acid was obtained, even though it was carried out at low temperatures (up to −30° C., see below). In a subsequent publication (Bean and Johnson, J. Am. Chem. Soc. 1932, 54, 4415) this loss of the boron group was even described as exclusive reaction during nitration of 4-methoxyphenylboronic acid. Herein also a later functionalisation of phenylboronic acids in para-position failed completely. The sensitivity of the boron-carbon-bond in arenes against electrophiles was demonstrated by bromolysation of phenylboronic acids by Kuivila and Hendrickson (J. Am. Chem. Soc. 1952, 74, 5068). Therein it became apparent that electron-poor phenylboronic acids were more stable than their electron-rich pendants, a fact which was later used for synthetic of a few electron-withdrawing substituted boronic acids (Torssell, Meyer, Zacharias, Ark. Kemi 1957, 10, 35, 497). The same publication also describes the preparation of 4-amino-3-nitrophenylboronic acid in a multistage sequence, starting with nitration of tolylboronic acid at low temperature (−40° C.), oxidation of the methyl group to an acid, introduction of an azide via the acid chloride, breakdown of the azide through Curtius reaction to an acetylamino group and saponification of the latter (14% total yield).

A further method to build up boronic acid derivatives is the transition-metal catalysed coupling of dioxaborolanes (see Murata et al., J. Org. Chem. 2000, 65, 164) or dioxaborolanyls (see Zaidlewicz et al., J. Organomet. Chem. 2002, 657, 129) with halogenoarenes. This reaction proceeds with haloanilines with 7% yield, however, to date not satisfactorily (Baudoin et al., J. Org. Chem. 2000, 65, 9268).

Further, the introduction of a boronic acid function in an aromatic nitro compound with subsequent hydration is conceivable. Due to the reactivity of the nitro-group this requires extremely low temperatures and is restricted to few substrates (see Köbrich et al., Angew. Chem. 1966, 78, 1062; Knochel et al., Angew. Chem. 2002, 114, 1680).

### SUMMARY OF ADVANTAGEOUS EMBODIMENTS OF THE INVENTION

It was therefore an object to provide a method by which aminoaryl- or aminoheteroarylboronic acids can be prepared - specifically those which carry an amino group in para-position to the boronic acid function - and derivatives thereof; which is compatible with many substituents and substitution patterns; which comprises neither multistage synthetic sequences nor technically difficult to master reactions, such as the Curtius breakdown; which further achieves high yields and is economically sensible. This is the prerequisite for technical production and further applicability of aminoaryl- or aminoheteroarylboronic acids.

### DETAILED DESCRIPTION OF ADVANTAGEOUS EMBODIMENTS OF THE INVENTION

The present invention fulfills these requirements and relates to a method for preparation of aminoaryl- or aminoheteroarylboronic acids of formula (VI) and derivatives thereof.

The invention generally relates to a method for preparation of aminoaryl- and aminoheteroarylboronic acids and esters and salts thereof, wherein an optionally substituted aminoaryl or aminoheteroaryl compound is protected at its nitrogen site via condensation with a carbonyl compound, subsequently metalated and then converted with a suitable boron compound, whereby after reconditioning and removal of the protective group the corresponding boronic acid, the anhydride or the boronic acid ester thereof is obtained (FORMULA 1 comprising Steps 1 through 3 below).

Step 1: Protection of the aminoarene or aminoheteroarene through condensation with a carbonyl compound

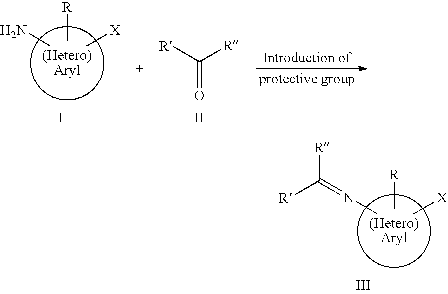

Step 2: Metalation of the protected aminoarene or aminoheteroarene; conversion to boronic acid derivative

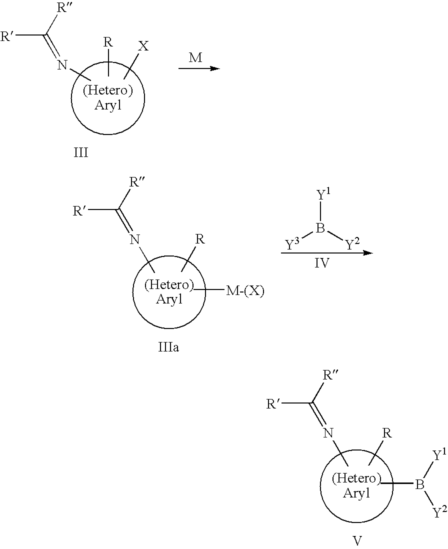

Step 3: Dissociation of the protective group

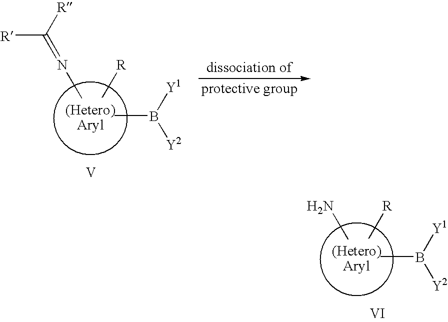

### Formula 1

The present invention more particularly comprises the reaction of an aminoarene or aminoheteroarene (I)

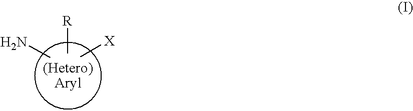

with a carbonyl compound (II)

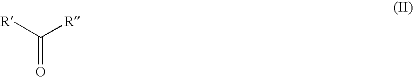

in which (I) is converted to a protected aminoarene or aminoheteroarene (III);

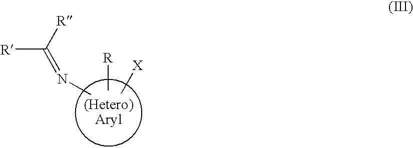

the metalation of (III) with simultaneous or subsequent conversion with a boronic compound (IV)

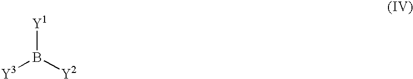

leads to a protected aminoaryl- or aminoheteroaryl-boronic compound of formula V;

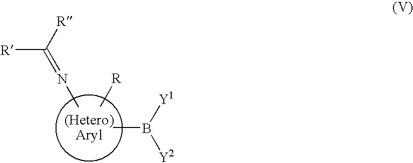

which by cleaving off the protective group by re-release of the carbonyl compound (II) is converted into the aminoaryl- or aminoheteroaryl-boronic compound of formula VI;

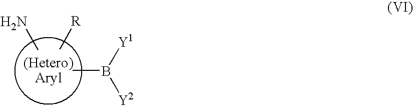

wherein
[symbol] represents a mono-, di-, tri- or poly-cyclic C₅- to C₂₀-aryl, in which 1 or 2 carbon atoms independently of each other can be replaced by O, N or N—R, preferably phenyl or pyrimidinyl;

R represents
H, F, Cl , Br, I,
C₁- to C₂₀-, preferably C₁- to C₈-alkyl or
C₁- to C₂₀-, particularly C₁- to C₈-alkoxy,
   wherein these alkyl and alkoxy radicals are branched or unbranched and, optionally, mono- or multiple-substituted,
C₆- to C₁₂-aryl, particularly phenyl,
C₆- to C₁₂-aryloxy,
heteroaryl,
heteroaryloxy,
C₃- to C₈-cycloalkyl, particularly cyclohexyl,
   wherein these aryl-, aryloxy-, heteroaryl-, heteroaryloxy- and cycloalkyl-radicals are optionally mono- or multiple-substituted,
di-(lower)-alkylamino,
diarylamino,
(lower)-alkylthio,
arylthio,
(lower)-alkyloxycarbonyl or
di-(lower)-alkyloxymethylen;

X represents
H, F, Cl, Br, or I, particularly Cl, Br or I;

Y¹, Y², Y³ independently of each other represents
H, F, Cl, Br or i, preferably Cl
C₁-C₂₀-alkyloxy, particularly C₁-C₈-alkyloxy, which is branched or unbranched and which optionally is mono or multiple substituted or two radicals Y¹⁻³ together form a ring.

According to the invention, “(lower)-alkyl” refers to a branched or unbranched C₁-C₆-, preferably C₁-C₄-alkyl radical, particularly to methyl, ethyl, propyl, isopropyl, butyl, isobutyl, tertiary butyl, pentyl or hexyl, particularly preferably methyl, ethyl, propyl or butyl.

According to the invention “mono- or multiple-substituted” or “substituted” means that the particular residue is substituted singly or, where possible, two, three or multiple times by halogen, preferably chlorine or bromine, and/or by nitro, cyano, hydroxy, (lower)-alkyl, (lower)-alkyloxy, amino, mono-(lower)-alkylamino, di-(lower)-alkylamino, monoarylamino, diarylamino, (lower)-alkylthio, arylthio, carboxyl and/or (lower)-alkyloxycarbonyl.

“Aryl”, when not explicitly stated, refers to a mono-, di-, tri- or poly-cyclic C₅- to C₂₀-aryl radical, particularly to phenyl, naphthyl, diphenyl or indenyl.

“Heteroaryl”, when not explicitly stated, refers to a mono-, di-, tri- or poly-cyclic C₅- to C₂₀-aryl radical, in which 1 or 2 carbon atoms independently of each other can be replaced by O, S, N, N-(lower)-alkyl or N-halogen, particularly to furyl, thiophenyl, oxazolyl, thiazolyl, pyridyl, pyrimidinyl, indolyl or benzofuranyl.

Derivatives of the compound of formula VI are to be understood, in particular, as salts such as compounds of formulas VIa and VIb.

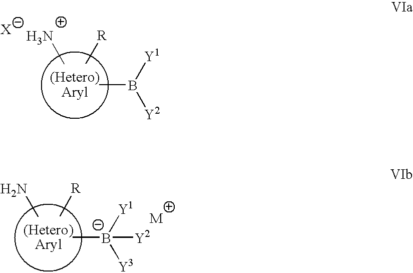

Compound (II) refers to all conceivable carbonyl compounds, which after condensation with the aminoarene or aminoheteroarene derivatives (I) form iminies, which are inert under the conditions of metalation and borylation and which are removable from (V) without loss of the boron containing function. Compounds that satisfy this condition are particularly those of formula II, in which the substituents
R′ and R″ independently of each other each represent, optionally mono or multiple substituted
   (lower)-alkyl-, aryl-, heteroaryl-, benzyl-, benzyloxycarbonyl-, particularly, phenyl- and substituted phenyl-groups, wherein
R′ and R″ also together with the C atom to which they are bound can form an optionally mono or multiple substituted cyclus (also referred to as a cyclic moiety), preferably a 5- to 7-membered cyclus, particularly a C₅- to C₇-cycloalkyl.

By introducing the carbonyl compound as protective group via condensation the N-bound hydrogen atoms are removed completely or masked in advance, such that the amine function cannot be deprotonated anymore in the subsequent metalation step. The formation of protected aminoarenes or aminoheteroarenes (III) is effected e.g. through reaction of an aminoarene or aminoheteroarene (I) with a carbonyl compound (II), wherein the generated water is removed from the equilibrium either by distillation via formation of a two-phase azeotrope or by adding a water extracting agent, optionally assisted by a free or polymer-bound inorganic or organic, acid or by a Lewis acid. As a polymer-bound acid is preferably employed an acidic cation exchanger, as an acid preferably p-toluenesulfonic acid, and as a water extracting agent preferably a 4 Å molecular sieve. Herein, benzophenone, substituted benzophenone, acetophenone or substituted acetophenone, as well as other sterically hindered ketones, such as di-tert-butylketone or substituted tert-butylketone are used as preferred carbonyl compound (II).

Preferably, X is chlorine, bromine or iodine. In case of metalation through halogen-metal exchange, e.g. with butyllithium, bromine is particularly preferred; in case of metalation with metallic lithium (lithiation) chlorine is particularly preferred.

As metalation reagents, by way of example Grignard compounds, diorganomagnesium compounds, organolithium compounds or triorgano-magnesium-at-complexes, as well as alkali metal diorganoamides, combinations of organolithium compounds and complexing agents, combinations of organolithium compounds and alkali metal alcoholates, or even the reactive metal, such as an alkali or alkaline earth metal, particularly sodium, lithium, magnesium or zinc in suitable form are used, where applicable, in the presence of a redox catalyst.

Through metalation of (III), compounds of formula IIIa are obtained, wherein M represents an optionally ligand-carrying alkali or alkaline earth metal, zinc or aluminum (see FORMULA 2), [(X) in formula IIIa refers to one or more ligand(s) X which may be but not necessarily must be bound/coordinated to the metal M].

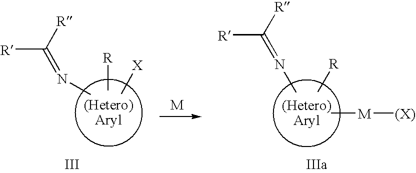

### Formula 2

Particularly preferred metalation reagents are secondary Grignard compounds such as isopropyl-, cyclohexyl- or cyclopentylmagnesium-halides, and primary or secondary alkyllithium compounds such as butyllithium, hexyllithium or cyclohexyllithium or metallic lithium in the presence of a catalyst.

The metalated compound (IIIa) thus obtained is converted with 0.6 to 5 molar equivalents, particularly 1.0 to 2.0 molar equivalents of a trisubstituted borate or borane (IV) respectively

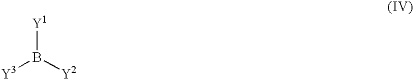

into compounds of formula V. Herein the radicals Y¹⁻³ have the aforesaid meaning. In case of Y¹⁻³=halide, compounds of formula V with Y¹═Y²═H are formed.

Preferably the radicals Y¹⁻³ are alkoxy radicals, wherein the alkoxy parts particularly preferably selected from the group consisting of linear or branched alkanes and cycloalkanes, specifically methyl, ethyl, propyl, butyl, isoproyl, isobutyl, tert-butyl, pentyl, isopentyl, neopentyl, cyclopentyl, hexyl, isohexyl, cyclohexyl, cycloheptyl, cyclooctyl etc.

The subsequent release of the amine function through cleavage of the protective group at the aminoarene- or aminoheteroarene-nitrogen atom, e.g. through hydrolysis or in a subsequent reaction step, leads to the desired aminoaryl- or aminoheteroarylboronic acid derivatives (VI).

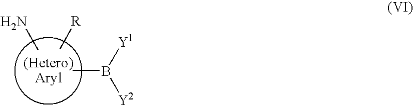

For removal of the protective group any method, known to the person skilled in the art, which under the applied conditions does not affect the other functions of the molecule, can be employed; e.g. hydrolysis by means of diluted or concentrated, free or polymer bound, inorganic or organic, acids or through addition of a highly volatile amine, which engages in an exchange reaction with the protected aminoarene or aminoheteroarene, whereby the protective group at the aminoarene- or aminoheteroarene-nitrogen atom is also removed. The hydrolysis preferably takes place in an aqueous environment in a temperature range of −20 to +80° C. under normal pressure in the presence of diluted hydrochloric or sulphuric acid, preferably at room temperature and already during the working-up or in a separate reaction step.

According to the invention all steps of the method are carried out in a solvent, at temperatures in the range of −100 to +120° C., preferably in the range of −85 to +40° C. Particularly, when using Grignard compounds in the metalation step the temperature is set in the preferred range; when using organolithium compounds it is preferably set in the range of −100 to −30° C. As organometallic reagents and intermediates are sensitive to humidity and oxygen, it is preferred to conduct the reaction under a dry inert gas such as nitrogen or argon.

In the method according to the invention the metalation step is carried out in an organic solvent or in an organic solvent mixture, preferably in an aliphatic, aromatic or etheric solvent or mixtures of such solvents, particularly preferably in solvents or solvent mixtures, which comprise at least one solvent selected from the group consisting of: tetrahydrofurane, glyme, diglyme, toluene, cyclohexane, pentane, hexane, isohexane or heptane, triethylamine, dialkylether, particularly diethyl ether, di-n-propylether, diisopropylether, dibutylether, 2-methyltetrahydrofurane, tert-butylmethylether, benzene, xylene, aniseed oil, petroleum ether, (alkane mixtures), methylcyclohexane.

Protecting and deprotecting steps are carried out either in-situ substance or in a suitable solvent, e.g. a solvent from the list of aforementioned solvents or solvent mixtures.

In the preferred embodiment, the aminoarene or aminoheteroarene (I) is initially converted with 1 to 50 equivalents, particularly preferably with 1 to 2.2 equivalents of a carbonyl compound (II) in a suitable solvent, typically in the presence of 0.01 to 0.25 equivalents of a suitable acid or Lewis acid, and the protected compound (III) is isolated.

In the preferred embodiment of the second step a Grignard compound is furnished at room temperature, or an alkyllithium compound at low temperature and the protected compound (III) is slowly metered in and thereby metalated through halogen-metal-exchange. Subsequently, the thus obtained suspension is mixed with the trisubstituted borane or borate (IV) and is stirred, expediently until complete conversion, whereby the temperature may be raised. Likewise, the compound (III) can be furnished and the organometallic compound can be metered in.

In an alternative single-step embodiment, the triorgano boronic acid ester [compound (IV) with Y¹⁻³=alkoxy], which in this case preferably carries sterically demanding substituents, is furnished with the protected compound (III) and the organometallic compound is metered in.

In a further alternative embodiment a protected lithio-aminoarene or -heteroaminoarene ((IIIa), X not present) can be prepared through deprotonation of an aminoarene or aminoheteroarene (III), wherein, in general as base either an alkyl or aryllithium compound, a lithiumamide (e.g. lithiumdiisopropylamide) or a combination of organolithium compound and complexing agent (e.g butyllithium and N,N,N′,N′-tetramethylethylenediamine) or a combination of organolithium compound and alkali metal alcoholate (e.g. butyllithium and potassium tert-butanolate) are employed. Also, in this case it is possible to furnish either the organometallic base or the compound (III), or a mixture of compounds (III) and (IV).

In a further alternative embodiment, the protected compound (III) is converted with a reactive metal, particularly lithium, sodium or magnesium, optionally in the presence of a catalyst in order to prepare the reactive metalated species. These can then be converted with the boric compound via one of the of the described methods. Likewise, the direct metalation of (III) can take place in the presence of the boronic acid ester.

The working-up generally takes place under the typical aqueous conditions, wherein (V) is obtained either as boronic acid ester, boronic acid or boronic acid anhydride. The cleaving-off of the protective groups, if not already taken place during the working-off of the boronic acid derivative, is carried out under precisely controlled conditions in a manner which is compatible with the functionalities of (V), particularly the boronate group, i.e. which leads to as little protodeboration as possible. The thus obtained aminoaryl- or aminoheteroaryl-boronic acid derivative (VI) may be further purified through re-crystallization or may be isolated as salt, e.g. as hydrochloride.

If required, the obtained aminoarene- or aminoheteroarene-boronic acid derivatives (VI) may be functionalised in a further step with or without intermediate isolation of (VI), at the boronic acid group through esterification or transesterification, particularly through polyhydric alcohols such as glycol, 1,3-dihydroxypropane or pinacol. Preferably, this functionalisation of compound (VI) takes place in a two-phased system water/organic solvent, in particular at a pH-value in the range of 7 to 14.

Equally well, the obtained aminoarene- or aminoheteroarene-boronic acid derivatives (VI) can be functionalised in a further step with or without intermediate isolation of (VI) at the amino group through alkylation or through formation of amide or carbamate, in particular through reaction with alkylhalides, inorganic or organic acid halides or anhydridic or organic dicarbonates, in particular di-tert-butyldicarbonate (boc anydride).

The obtained aminoaryl- or aminoheteroaryl-boronic acid derivatives, in particular aminophenylboronic acids, esters and anhydrides can be used without any problems in Suzuki couplings. The method provides a simple, cost effective path for synthetic of these compounds with good yield.

An advantage of the method according to the invention is the good accessibility of aminoaryl- or aminoheteroaryl-boronic acid derivatives of formula VI, in particular of 4-aminophenyl boronic acid derivatives (the para-compounds), which are not accessible by the known methods. Further advantages of the method according to the invention can be seen in that the introduction of protective groups does not require expensive organometallic bases such as alkyllithium, and in that the protected amino group is inert against metalation of the aromatic ring in a wide temperature range, such that cryogenic conditions are often dispensable.

The method of the present invention is illustrated by the following examples.

### EXAMPLES

### Example 1

### 3-aminophenylboronic acid pinacol ester through halogen-metal exchange using n-butyllithium at benzhydryliden-(3-bromo-phenyl)-amine

A mixture of 208.9 g (1.22 mole) 3-bromo aniline, 211.8 g (1.16 mole) benzophenone and 11.1 g (58.2 mmole) p-toluenesulfonic acid in 1000 g toluene is heated to boiling for 24 h under reflux, whereby the generated water is removed. Eventually obtained solid substance is filtered, the filtrate is freed from toluene by distillation. The residue is brought to crystallisation through slow addition of methanol in the cold. The crystals are sucked, washed with toluene and dried under vacuum. The thus prepared solid is the protected amine benzhydryliden-(3-bromo-phenyl)-amine. Yield: 313.9 g (0.933 mole, 77%)

20.0 g (59.5 mmole) benzhydryliden-(3-bromo-phenyl)-amine are dissolved in 147 g dry THF and cooled to −78° C. At this temperature 17.8 g (65.5 mmole) of 2.5 M n-butyllithium solution in hexane is slowly added. The mixture is continually stirred for 60 min and then cooled to −85° C. 7.45 g (71.5 mmole) of trimethylborate are slowly added. The mixture is again stirred for 60 min, then left to warm up to −10° C. and then poured into a prepared solution of 9.69 g of 96% sulphuric acid in 133.4 g water covered with a layer of 50 g toluene. The mixture is intensely stirred for one hour After completion of phase separation the aqueous phase is covered with a layer of 200 g of fresh toluene and 8.45 g (71.5 mmole) pinacol are added. By adding 55.5 g of 10% sodium hydroxide solution a pH-value of about 8.5 is set. The mixture is stirred intensely for 12 h, then again phase separation takes place. From the organic phase the bulk of the solvent is removed at 100-150 mbar. The residue is cooled to −5° C. The thereby obtained solid substance is sucked off, washed and dried under vacuum.

Thus, colorless crystals of 3-aminophenylboronic acid pinacol ester are obtained.

Yield:

10.1 g (46.1 mmole, 77%). Yield over all steps: 59%.

### Example 2

### 2-aminophenylboronic acid pinacol ester through halogen-metal exchange using n-butyllithium at benzhydryliden-(2-bromo-phenyl)-amine

2-bromide aniline is protected, converted and reconditioned as described in example 1 for 3-bromide aniline. Thus, 2-aminophenylboronic acid pinacol ester is obtained with 56% yield (over all steps).

### Example 3

### [3-(4,4,5,5-tetramethyl-[1,3,2]dioxaborolan-2-yl)-phenyl]-carbamin acid-tert-butylester through halogen-metal exchange using n-butyllithium at benzhydryliden-(3-bromo-phenyl)-amine

The synthetic of 3-aminophenylboronic acid pinacol ester is carried out as described in example 1. After completion of pinacolisation and phase separation the mixture is, however, not concentrated, rather the remaining organic phase is azeotropically dried. The residue, after adding 15.6 g (71.5 mmole) of di-tert-butyl-dicarbonate (boc-anhydride) is stirred at 80° C. for 12 h. Thereafter the bulk of the solvent is removed by distillation and the mixture is cooled to −5° C. Thereby the product crystallizes in the form of colorless crystals and can be isolated by filtration. Thus, 12.5 g (39.2 mmole, 85%) [3-(4,4,5,5-tetramethyl-[1,3,2]dioxaborolan-2-yl)-phenyl]-carbamic acid tert-butylester are obtained.

Yield over all steps: 66%.

### Example 4

### N-[3-(4,4,5,5-tetramethyl-[1,3,2]dioxaborolan-2-yl)-phenyl]-acetamide through halogen-metal exchange using n-butyllithium at benzhydryliden-(4-bromo-phenyl)-amine

The synthetic of 3-aminophenylboronic acid pinacol ester is carried out as described in example 1. After completion of pinacolisation and phase separation the mixture is, however, not concentrated, rather the remaining organic phase is azeotropically dried. The residue, after adding 7.3 g (71.5 mmole) of acetic acid anhydride is stirred at 80° C. for 12 h. Thereafter the bulk of the solvent is removed by distillation and the mixture is cooled to −5° C. Thereby the product crystallizes in the form of colorless crystals and can be isolated by filtration. Thus, 9.37 g (35.9 mmole, 78%) of N-[3-(4,4,5,5-tetramethyl-[1,3,2]dioxaborolan-2-yl)-phenyl]-acetamide are obtained.

Yield over all steps: 60%.

### Example 5

### N-[3-(4,4,5,5-tetramethyl-[1,3,2]dioxaborolan-2-yl)-phenyl]-methanesulfonamide through halogen-metal exchange using n-butyllithium at benzhydryliden-(4-bromo-phenyl)-amine

The synthetic of 3-aminophenylboronic acid pinacol ester is carried out as described in example 1. After completion of pinacolisation and phase separation the mixture is, however, not concentrated, rather the remaining organic phase is azeotropically dried. The residue, after adding 8.2 g (71.5 mmole) of methanesulfonyl chloride is stirred at 80° C. for 12 h. Thereafter the bulk of the solvent is removed by distillation and the mixture is cooled to −5° C. Thereby the product crystallizes in the form of colorless crystals and can be isolated by filtration. Thus, 10.9 g (36.6 mmole, 79%) of N-[3-(4,4,5,5-tetramethyl-[1,3,2]dioxaborolan-2-yl)-phenyl]-methanesulfonamide are obtained.

Yield over all steps: 62%

### Example 6

### 4-amino-3-methoxyphenylboronic acid pinacol ester through halogen-metal exchange using n-butyllithium at benzhydryliden-(4-bromo-2-methoxyphenyl)-amine

A mixture of 246.6 g (1.22 mole) 4-bromo-2-methoxyaniline, 211.8 g (1.16 mole) benzophenone and 11.1 g (58.2 mmole) p-toluenesulfonic acid in 1000 g toluene is heated to boiling for 24 h under reflux, whereby the generated water is removed. Eventually obtained solid substance is filtered, the filtrate is distillatively freed from toluene. The crystallization of the residue is initiated by slow addition of methanol in the cold. The crystals are sucked off, washed with toluene and dried under vacuum. The thereby prepared solid is the protected amine benzhydryliden-(4-bromo-2-methoxyphenyl)-amine.

Yield: 305.9 g (0.835 mole, 72%).

25.0 g (68.3 mmole) benzhydryliden-(4-bromo-2-methoxyphenyl)-amine are dissolved in 170 g dry THE and cooled to −78° C. At this temperature 20.4 g (75.1 mmole) of 2.5 M n-butyllithium solution in hexane is slowly added. The mixture is continually stirred for 60 min and then cooled to −85° C. 8.55 g (82.0 mmole) of trimethylborate are slowly added. The mixture is again stirred for 60 min, then left to warm up to −10° C. and then poured into a prepared solution of 11.1 g of 96% sulphuric acid in 153 g water covered with a layer of 60 g toluene. The mixture is intensely stirred for one hour. After completion of phase separation the aqueous phase is covered with a layer of 230 g of fresh toluene and 9.69 g (82.0 mmole) pinacol are added. By adding 63.7 g of 10% sodium hydroxide solution a pH-value of about 8.5 is set. The mixture is stirred intensely for 12 h, then again phase separation takes place. From the organic phase the bulk of the solvent is removed at 100-150 mbar. The residue is cooled to −5° C. The thereby obtained solid substance is sucked off, washed and dried under vacuum. Thus, colorless crystals of 4-aminophenylboronic acid pinacol ester are obtained.

Yield: 11.7 g (47.1 mmole, 69%).

Yield over all steps: 50%.

### Example 7

### [2-methoxy-4-(4,4,5,5-tetramethyl-[1,3,2]dioxaborolan-2-yl)-phenyl]-carbamin acid-tert-butylester through halogen-metal exchange using n-butyllithium at benzhydryliden-(4-bromo-2-methoxyphenyl)-amine

The synthetic of 4-amino-3-methoxyphenylboronic acid pinacol ester is carried out as described in example 6. After completion of pinacolisation and phase separation the mixture is, however, not concentrated, rather the remaining organic phase is azeotropically dried. The residue, after adding 17.9 g (82.0 mmole) of di-tert-butyl-dicarbonate (boc-anhydride) is stirred at 80° C. for 12 h. Thereafter the bulk of the solvent is removed by distillation and the mixture is cooled to −5° C. Thereby the product crystallizes in the form of colorless crystals and can be isolated by filtration. Thus, 10.5 g (30.1 mmole, 64%) [2-methoxy-4-(4,4,5,5-tetramethyl-[1,3,2]dioxaborolan-2-yl)-phenyl]-carbamine acid-tert-butylester are obtained.

Yield over all steps: 44%.

### Example 8

### (2-aminopyrimidin-5-yl)-boronic acid pinacol ester through halogen-metal exchange using n-butyllithium at 5-bromo-pyrimidin-2-ylamin

A mixture of 212.3 g (1.22 mole) 5-bromo-pyrimidin-2-ylamin, 211.8 g (1.16 mole) benzophenone and 11.1 g (58.2 mmole) p-toluenesulfonic acid in 1000 g toluene is heated to boiling for 24 h under reflux, whereby the generated water is removed. Eventually obtained solid substance is filtered, the filtrate is distillatively freed from toluene. Crystallization of the residue is initiated by slow addition of methanol in the cold. The crystals are sucked off, washed with toluene and dried under vacuum. The thereby prepared solid is the protected amine benzhydryliden-(5-bromo-pyrimidin-2-yl)-amine.

Yield: 286.5 g (0.847 mole, 73%).

25.0 g (73.9 mmole) benzhydryliden-(5-bromo-pyrimidin-2-yl)-amine are dissolved in 185 g dry THF and cooled to −78° C. At this temperature 22.1 g (81.3 mmole) of 2.5 M n-butyllithium solution in hexane is slowly added. The mixture is continually stirred for 60 min and then cooled to −85° C. 9.25 g (88.7 mmole) of trimethylborate are slowly added. The mixture is again stirred for 60 min, then left to warm up to −10° C. and then poured into a prepared solution of 12.0 g of 96% sulphuric acid in 166 g water covered with a layer of 65 g toluene. The mixture is intensively stirred for one hour. After completion of phase separation the aqueous phase is covered with a layer of 249 g of fresh toluene and 10.5 9 (88.7 mmole) pinacol are added. By adding 68.9 g of 10% sodium hydroxide solution a pH-value of about 8.5 is set. The mixture is stirred intensely for 12 h, then again phase separation takes place. From the organic phase the bulk of the solvent is removed at 100-150 mbar. The residue is cooled to −5° C. The thereby obtained solid substance is sucked off, washed and dried under vacuum. Thus, colorless crystals of (2-aminopyrimidin-5-yl)-boronic acid pinacol ester are obtained.

Yield: 12.1 g (54.7 mmole, 74%).

Yield over all steps: 54%.

### Example 9

### [5-(4,4,5,5-tetramethyl-[1,3,2]dioxaborolan-2-yl)-pyrimidin-2-yl]-carbamic acid-tert-butylester through halogen-metal exchange using n-butyllithium at benzhydryliden-(5-bromo-pyrimidin-2-yl)-amine

The synthetic of (2-amino-pyrimidin-5-yl)-boronic pinacol ester is carried out as described in example 8. After completion of pinacolisation and phase separation the mixture is, however, not concentrated, rather the remaining organic phase is azeotropically dried. The residue, after adding 19.4 g (88.7 mmole) of di-tert-butyl-dicarbonate (boc-anhydride) is stirred at 80% for 12 h. Thereafter the bulk of the solvent is removed by distillation and the mixture is cooled to −5° C. Thereby the product crystallizes in the form of colorless crystals and can be isolated by filtration. Thus, 12.5 g (38.8 mmole, 71%) [5-(4,4,5,5-tetramethyl-[1,3,2]dioxaborolan-2-yl)-pyrimidin-2-yl]-carbamic acid-tert-butylester are obtained.

Yield over all steps: 38%.

### Example 10

### 3-aminophenylboronic acid pinacol ester through halogen-metal exchange using isopropylmagnesiumbromide at benzhydryliden-(3-bromo-phenyl)-amine

The synthetic and isolation of benzhydryliden-(3-bromo-phenyl)-amine is carried out as described in example 1.

20.0 g (59.5 mmole) benzhydryliden-(3-bromo-phenyl)-amine are dissolved in 147 g dry THF and cooled to −20° C. At this temperature 9.65 g (65.5 mmole) of isopropylmagnesiumbromide, dissolved in 100 g dry THF, is slowly added. The mixture is continually stirred for 60 min. 7.45 g (71.5 mmole) of trimethylborate are slowly added. The mixture is again stirred for 60 min, then left to warm up to −10° C. and then poured into a prepared solution of 11.6 g of 96% sulphuric acid in 160.1 g water covered with a layer of 50 g toluene. The mixture is intensely stirred for one hour. After completion of phase separation the aqueous phase is covered with a layer of 200 g of fresh toluene and 8.45 g (71.5 mmole) pinacol are added. By adding 66.9 g of 10% sodium hydroxide solution a pH-value of about 8.5 is set. The mixture is stirred intensely for 12 h, then again phase separation takes place. From the organic phase the bulk of the solvent is removed at 100-150 mbar. The residue is cooled to −5° C. The thereby accrued solid substance is sucked off, washed and dried under vacuum. Thus, colorless crystals of 3-aminophenylboronic acid pinacol ester are obtained.

Yield: 9.21 g (42.0 mmole, 70%).

Yield over all steps: 54%.

That which is claimed:

1. Method for preparation of aminoaryl- or aminoheteroaryl-boronic acid derivatives of formula VI, VIa or VIb 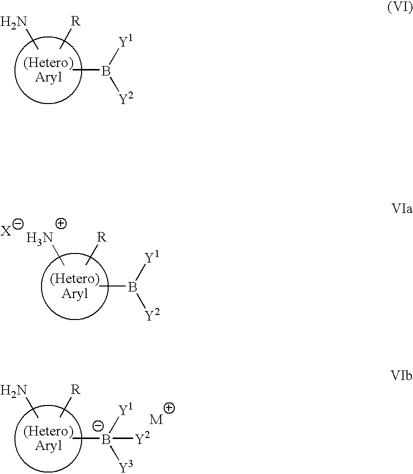
said method comprising converting an aminoarene or aminoheteroarene (i) 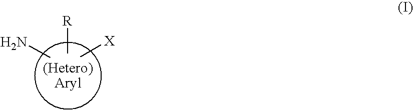
with a protecting-group carbonyl compound (II) 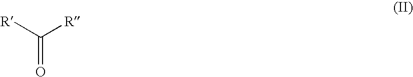
to form a protected aminoarene or aminoheteroarene (III) 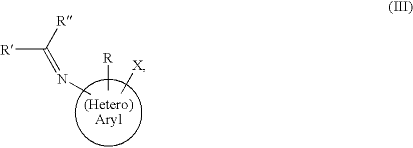
metalating (III) with simultaneous or subsequent converting with a boronic compound (IV) 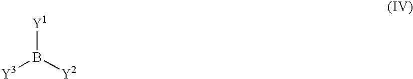
to form a protected aminoaryl- or aminoheteroaryl-boronic compound of formula V, 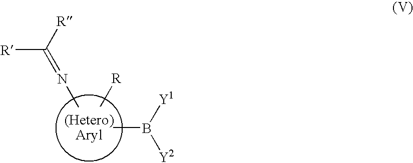
and removing the protective-group to convert (V) into the aminoaryl- or aminoheteroaryl-boronic compound of formula VI, 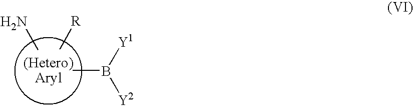
wherein [symbol]
represents a mono-, di-, tri- or poly-cyclic C₅- to C₂₀-aryl, in which 1 or 2 carbon atoms independently of each other can be replaced by O, N or N—R;
R represents
H, F, Cl, Br, I,
C₁- to C₂₀-alkyl or
C₁- to C₂₀-alkoxy,
wherein the alkyl and alkoxy radicals are branched or unbranched and optionally mono- or multiple-substituted,
C₆- to C₁₂-aryl,
C₆- to C₁₂-aryloxy,
heteroaryl,
heteroaryloxy,
C₃- to C₈-cycloalkyl,
wherein the aryl-, aryloxy-, heteroaryl-, heteroaryloxy- and cycloalkyl radicals are unsubstituted mono- or multiple-substituted,
di-(lower)-alkylamino,
diarylamino,
(lower)-alkylthio,
arylthio,
(lower)-alkyloxycarbonyl or
di-(lower)-alkyloxymethylene;
X represents
H, F, Cl, Br, or I;
Y¹, Y², Y³, independently of each other, represents
H, F, Cl, Br or I,
C₁-C₂₀-alkyloxy, which is branched or unbranched and optionally mono
or multiple substituted,
or two radicals Y¹⁻³ together form a ring.

2. A method according to claim 1, wherein the compound (II) is a carbonyl compound which after condensation with the aminoarene or aminoheteroarene derivative (I), with or without assistance of an acid or Lewis acid forms an imine, which is further inert under metalation and borylation conditions and which also can be removed from (V) without loss of the boron-containing function.

3. A method according to claim 1, wherein
R′ and R″ independently from each other each represent an unsubstituted or mono or multiple substituted (lower)-alkyl-, aryl-, heteroaryl-, benzyl-, benzyloxycarbonyl-group,
or wherein
R′ and R″ together with the C-atom to which they are bound form an unsubstituted or single or multiple substituted cyclic moiety.

4. A method according to claim 3, wherein R′ is unsubstituted or mono or multiple substituted phenyl, methyl or tert-butyl and R″ is unsubstituted or mono or multiple substituted phenyl or tert-butyl.

5. A method according to claim 1, wherein the conversion of (I) with the carbonyl compound (II)
takes place in the presence of a free or polymer bound inorganic or organic acid or Lewis acid, or an acidic cation-exchanger,
and/or
the generated water is removed by azeotropic distillation or by addition of a water extracting agent.

6. A method according to claim 1, wherein the protective groups are removed through hydrolysis in a water-containing medium in the presence of a free or polymer-bound inorganic or organic acid in a temperature range of −20 to +80° C., wherein said water-containing medium is already present during working-up or provided in a separate reaction step.

7. A method according to claim 1, wherein the compound (III) is converted into a metalated compound (IIIa), 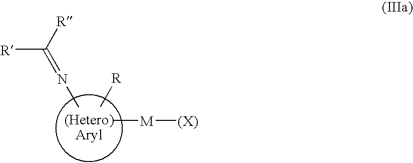
wherein M stands for an alkali or alkaline earth metal, zinc or aluminum.

8. A method according to claim 7, wherein the protected aminoarene or aminoheteroarene derivative (III) is converted with an organomagnesium or organolithium compound into the metalated protected aminoarene or aminoheteroarene (IIIa)

9. A method according to claim 7, wherein the metalation takes place under participation of a redox catalyst, in the presence or absence of a solvent.

10. A method according to claim 7, wherein the metalation is carried out in a solvent or solvent mixture containing at least one solvent selected from the group comprising triethylamine, diethyl ether, di-n-propylether, diisopropylether, dibutylether, tetrahydrofurane, 2-methyltetrahydrofurane, tert-butyl methylether, benzene, toluene, xylene, anisol, pentane, hexane, isohexane, heptane, petroleum ether, mixture of alkanes, cyclohexane, and methylcyclohexane.

11. A method according to claim 1, wherein the metalating step comprises providing a metalation agent then metering in the protected aminoarene or aminoheteroarene (III) to the metalation agent, and subsequently converting with trisubstituted borane or borate (IV) optionally dissolved in a solvent.

12. A method according to claim 1, wherein the metalating step comprises providing a metalation agent in a solvent and metering in, either simultaneously or as a mixture, the protected aminoarene or aminoheteroarene (III) and the trisubstituted borane or borate (IV), of which one or both may be dissolved in a solvent.

13. A method according to claim 1, wherein the protected aminoarene or aminoheteroarene (III) is provided and then the metalation agent, which may be dissolved in a solvent, is metered in to form a reaction mixture, and finally the trisubstituted borane or borate (IV), which may be dissolved in a solvent, is reacted with the reaction mixture.

14. A method according to claim 1, wherein the protected aminoarene or aminoheteroarene (III) and the trisubstituted borane or borate (IV) are provided and the metalation agent, which may be dissolved in a solvent, is metered in.

15. A method according to claim 1, wherein the protected aminoarene or aminoheteroarene (III) is converted in a solvent in the presence of the trisubstituted borane or borate (IV) respectively with a reactive metal selected from alkali metal, alkaline earth metal, and zinc.

16. A method according to claim 1, wherein the method is carried out at a temperature in the range of −100 to +120° C.

17. A method according to claim 1, wherein the metalation, in the case of using a Grignard compound is carried out at a temperature in the range of 0 to +40° C., and in the case of using an organolithium compound at a temperature in the range of −100 to −30° C.

18. A method according to claim 1, wherein said method further comprises a further step with or without intermediate isolation of (VI) at the boronic acid group, said step comprising functionalizing the prepared aminoarene- or aminoheteroarene-boronic acid derivatives (VI) by esterification or transesterification.

19. A method according to claim 1, wherein the esterification or transesterification is carried out by multi-valenced alcohols at the boronic acid group of the compound (VI) in a two-phase system water/organic solvent at a pH-value in the range of 7 to 14.

20. A method according to claim 1, wherein said method comprises a further step, with or without intermediate isolation of (VI) at the amino group, said step comprising functionalizing the prepared aminoarene- or aminoheteroarene-boronic acid derivatives (VI) through alkylation or through amide or carbamate formation.

21. Suzuki coupling or Petasis reactions comprising aminoarene- or aminoheteroarene-boronic acid derivatives of formula VI prepared by a method according to claim 1.

22. Suzuki coupling or Petasis reactions comprising aminoarene- or aminoheteroarene-boronic acid derivatives of formula V prepared by a method according to claim 1.

23. Compounds of formula V, 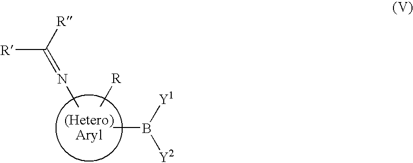
wherein [symbol]
represents mono-, di-, tri- or poly-cyclic C₅- to C₂₀-aryl, in which 1 or 2 carbon atoms independently of each other can be replaced by O, N or N—R;
R represents
H, F, Cl, Br, I,
C₁- to C₂₀-alkyl or
C₁- to C₂₀-alkoxy,
wherein the alkyl and alkoxy radicals are branched or unbranched and unsubstituted or mono- or multiple-substituted,
C₆- to C₁₂-aryl,
C₆- to C₁₂-aryloxy,
heteroaryl,
heteroaryloxy,
C₃- to C₈-cycloalkyl,
wherein the aryl-, aryloxy-, heteroaryl-, heteroaryloxy- and cycloalkyl radicals are unsubstituted, mono- or multiple-substituted,
di-(lower)-alkylamino,
diarylamino,
(lower)-alkylthio,
arylthio,
(lower)-alkyloxycarbonyl or
di-(lower)-alkyloxymethylene;
Y¹, Y² independently of each other stand for
H,
C₁-C2₀-alkyloxy, wherein the alkyl part is branched or unbranched and unsubstituted, mono or multiple substituted,
or the two radicals Y¹ and Y² together form a ring; and
R′ and R″, independently of each other each may be mono or multiple substituted (lower)-alkyl-, aryl-, heteroaryl-, benzyl-, benzyloxycarbonyl-, wherein
R′ and R″, also together with the C-atom to which they are bound, can form a cyclic moiety, which may be mono or multiple substituted.

24. Method according to claim 1, wherein [symbol]
represents phenyl or pyrimidine;
R represents
H, F, Cl, Br, I,
C₁- to C₈-alkyl or
C₁- to C₈-alkoxy,
wherein these alkyl and alkoxy radicals are branched or unbranched and optionally mono- or multiple-substituted,
phenyl,
C₆- to C₁₂-aryloxy,
heteroaryl,
heteroaryloxy,
cyclohexyl,
wherein these aryl-, aryloxy-, heteroaryl-, heteroaryloxy- and cycloalkyl radicals are unsubstituted mono- or multiple-substituted,
di-(lower)-alkylamino,
diarylamino,
(lower)-alkylthio,
arylthio,
(lower)-alkyloxycarbonyl or
d i-(lower)-alkyloxymethylene;
X represents
Cl, Br or I;
Y¹, Y², Y³, independently of each other, represents
Cl
C₁-C₈-alkyloxy, which is branched or unbranched and optionally mono
or multiple substituted,
or two radicals Y¹⁻³ together form a ring.

25. The method of claim 3, wherein
R′ and R″ independently from each other each represent an unsubstituted or mono or multiple substituted (lower)-alkyl-, phenyl- and substituted phenyl-group,
or wherein
R′ and R″ together with the C-atom, to which they are bound, form an unsubstituted or single or multiple substituted 5- to 7-membered cyclic moiety.

26. The method of claim 25, wherein
R′ and R″ independently from each other each represent an unsubstituted or mono or multiple substituted (lower)-alkyl-, phenyl- and substituted phenyl-group,
or wherein
R′ and R″ together with the C-atom, to which they are bound, form an unsubstituted or single or multiple substituted C₅- to C₇-cycloalkyl.

27. A method according claim 5, wherein the reaction of (I) with the carbonyl compound (II)
takes place in the presence of p-toluenesulfonic acid,
and/or
the generated water is removed by azeotropic distillation or by addition of a 4 Å molecular sieve.

28. A method according to claim 18, wherein, in a further step with or without intermediate isolation of (VI) at the boronic acid group, the prepared aminoarene- or aminoheteroarene-boronic acid derivatives (VI) are functionalised through multi-valenced alcohols

29. A method according to claim 28, wherein said multi-valenced alcohols are glycol, 1,3-dihydroxypropane or pinacol.

30. A method according to claim 20, wherein, in a further step with or without intermediate isolation of (VI) at the amino group, the prepared aminoarene- or aminoheteroarene-boronic acid derivatives (VI) are functionalised through reaction with alkylhalides, inorganic or organic acid halides or -anhydrides or organic dicarbonates.

31. A method according to claim 30, wherein, in a further step with or without intermediate isolation of (VI) at the amino group, the prepared aminoarene- or aminoheteroarene-boronic acid derivatives (VI) are functionalised through reaction with alkylhalides, inorganic or organic acid halides or -anhydrides or di-tert-butyl-dicarbonate.

32. A compound according to claim 23, [symbol]
represents phenyl or pyrimidine;
R represents
H, F, Cl, Br, I,
C₁- to C₈-alkyl or
C₁- to C₈-alkoxy,
wherein these alkyl and alkoxy radicals are branched or unbranched and unsubstituted or mono- or multiple-substituted,
phenyl,
C₆- to C₁₂-aryloxy,
heteroaryl,
heteroaryloxy,
cyclohexyl,
wherein these aryl-, aryloxy-, heteroaryl-, heteroaryloxy- and cycloalkyl radicals are unsubstituted, mono- or multiple-substituted,
di-(lower)-alkylamino,
diarylamino,
(lower)-alkylthio,
arylthio,
(lower)-alkyloxycarbonyl or
di-(lower)-alkyloxymethylene;
Y¹, Y² independently of each other stand for
H,
C₁-C₈-alkyloxy, wherein the alkyl part is branched or unbranched and unsubstituted, mono or multiple substituted, or the two radicals y¹ and y² together form a ring; and
R′ and R″, independently of each other each may be mono or multiple substituted (lower)-alkyl-, phenyl- and substituted phenyl-groups, wherein
R′ and R″, also together with the C-atom to which they are bound, can form a 5- to 7-membered cyclic moiety.

33. A compound according to claim 32, wherein
R′ and R″, also together with the C-atom to which they are bound, can form a C₅- to C₇-cycloalkyl.
